(19) United States
(12) Patent Application Publication
(10) Pub. No.: US 2025/0025840 A1
(43) Pub. Date: Jan. 23, 2025

(54) High-Efficiency Degassing Polyolefin Hollow Fiber Membrane and Preparation Therefor and Use Thereof

(71) Applicant: Hangzhou Cobetter Filtration Equipment Co., Ltd., Hangzhou (CN)

(72) Inventors: Jiandong Jia, Hangzhou (CN); Mengze Chen, Hangzhou (CN)

(21) Appl. No.: 18/907,590

(22) Filed: Oct. 7, 2024

Related U.S. Application Data
(63) Continuation of application No. PCT/CN2023/099655, filed on Jun. 12, 2023.

(30) Foreign Application Priority Data
Jul. 11, 2022 (CN) 202210812499.0

(51) Int. Cl. B01D 69/08; B01D 19/00; B01D 67/00; B01D 69/02; B01D 71/26; C02F 1/20; C02F 101/10; C02F 103/04

(52) U.S. Cl. CPC B01D 69/081; B01D 19/0031; B01D 67/0027; B01D 67/0083; B01D 69/02; B01D 69/087; B01D 71/262; C02F 1/20; B01D 2323/081; B01D 2323/082; B01D 2323/42; B01D 2325/021; B01D 2325/0231; B01D 2325/02833; B01D 2325/04; B01D 2325/20; B01D 2325/24; B01D 2325/28; C02F 2101/10; C02F 2103/04

(57) ABSTRACT

The present disclosure provides a high-efficiency degassing polyolefin hollow fiber membrane and a preparation therefor and use thereof. The membrane comprises a main body, wherein one side of the main body is an inner surface facing an inner cavity, the other side of the main body is an outer surface, a non-directional tortuous pathway is formed in the main body, the outer surface is a dense surface, and the area ratio of air pores in the inner surface is 10%-30%; the average thickness of the hollow fiber membrane is 45-65 m and the ratio of the average outer diameter to the average inner diameter of the hollow fiber membrane is 1.45-1.55; the TOC dissolving-out amount of the hollow fiber membrane itself is less than or equal to 0.5 μg/L; and the deoxidation efficiency of the hollow fiber membrane is greater than 80%.

### CROSS-REFERENCE TO RELATED APPLICATIONS

The present application is a continuation application of PCT application No. PCT/CN2023/099655 filed on Jun. 12, 2023, which claims the benefit of Chinese Patent Application No. 202210812499.0 filed on Jul. 11, 2022. The contents of all of the aforementioned applications are incorporated by reference herein in their entirety.

### TECHNICAL FIELD

The present application relates to the field of materials for degassing membranes and particularly relates to a high-efficiency degassing polyolefin hollow fiber membrane and a preparation therefor and use thereof.

### BACKGROUND

Since the polyolefin is rich in raw materials, low in price, easy for processing and shaping, and excellent in comprehensive performance, the polyolefin is a high polymer material with large output and wide application. The polyolefin has the characteristics of small relative density, chemical resistance, water resistance and the like. The polyolefin can be used for films, pipes, plates, various formed products, wires and cables and the like.

Degassing membranes are membrane separation products that remove gases from liquids, such as carbon dioxide, oxygen and ammonia nitrogen. Currently, the main methods for preparing such membranes are stretching for pore-forming and thermally induced phase separation. The stretching for pore-forming is melting and extruding a crystalline polymer into a hollow fiber membrane or a thin membrane, and then post-treating the membrane to subject the polymer to bidirectional stretching along the extrusion direction, thereby improving the shapes and sizes of membrane pores and the porosity. The thermally induced phase separation is that since some polymer materials cannot be dissolved at normal temperature, when the temperature is raised to be higher than the melting temperature, the polymer materials and some small molecular compounds (diluents) can form a uniform solution, after the temperature is reduced, the uniform solution is subjected to solid-liquid or liquid-liquid phase separation to be solidified, and after the diluents are removed, a microporous material is obtained.

Patent CN107998903A discloses a method for preparing a polypropylene hollow fiber microporous membrane used in the fields of membrane distillation and membrane degassing, and obtains the polypropylene hollow fiber microporous membrane by using polypropylene as a raw material and a higher aliphatic amine ethylene oxide adduct as a diluent through a thermally induced phase separation. The hollow fiber microporous membrane prepared by the patent has a through and spongy microporous structure section and a microporous distribution surface.

In the above patent, the through porous hollow fiber membrane inside and outside is prepared by the thermally induced phase separation. The hollow fiber membrane prepared by the thermally induced phase separation requires the addition of a diluent. Finally, the prepared hollow fiber membrane inevitably contains the residue of the diluent. The residue is likely to undergo a dissolution reaction during a degassing treatment of ultrapure water and has a great influence on the quality of the ultrapure water. Therefore, the filter membrane prepared by the thermally induced phase separation is not suitable for the field of ultrapure water preparation. In addition, although the through porous hollow fiber membrane inside and outside has a good degassing effect, the through microporous structure inside and outside is likely to allow a fluid to flow in. Once the fluid flows in, the membrane loses its ability to separate gas and liquid, resulting in a low service life.

Through the constant search of those skilled in the art, the asymmetric hollow fiber membrane body exhibits excellent performance, wherein the asymmetric hollow fiber membrane has a dense outer surface (a pore structure that cannot be observed or a very small number of pore structures that can be observed) and a support layer with a porous structure, and the dense outer surface can effectively prevent the fluid from flowing into the hollow fiber membrane, thereby reducing the service life. However, the preparation process of the prior asymmetric hollow fiber membrane is not mature. The problems of how to prepare the hollow fiber membrane with higher porosity, high deoxidation efficiency, high mechanical strength and long service life always trouble researchers.

### SUMMARY

In order to solve the above problems, the present disclosure aims to provide a high-efficiency degassing polyolefin hollow fiber membrane and a preparation therefor and use thereof. The hollow fiber membrane prepared by the present application has higher deoxidation efficiency and higher tensile strength, improves the performance of the degassing polyolefin hollow fiber membrane and prolongs its service life.

To achieve the above objective, the present disclosure provides the following technical solutions.

A high-efficiency degassing polyolefin hollow fiber membrane includes a main body, wherein one side of the main body is an inner surface facing an inner cavity, the other side of the main body is an outer surface, a non-directional tortuous pathway is formed in the main body, the outer surface is a dense surface, and the area ratio of air pores in the inner surface is 10%-30%; the average thickness of the hollow fiber membrane is 45-65 m and the ratio of the average outer diameter to the average inner diameter of the hollow fiber membrane is 1.45-1.55; the TOC dissolving-out amount of the hollow fiber membrane is less than or equal to 3 μg/L; and the deoxidation efficiency of the hollow fiber membrane is greater than 80%.

It should be noted that when the dense surface is photographed by a scanning electron microscope at 30,000 times, the pore area ratio (i.e., pore area:outer surface area) of the outer surface is less than or equal to 5%, namely a pore structure cannot be observed or a very small number of pore structures can be observed. One side of the main body of the present application is the inner surface close to the inner cavity and the other side of the main body is the outer surface. The outer surface is a dense surface and has strong hydrophobicity, such that water molecules can hardly pass through and oxygen can pass through. The oxygen can permeate through the membrane pores in a coexistent manner of Knudsen diffusion and viscous flow in the hollow fiber membrane. When the oxygen is close to the dense surface, the oxygen permeates through the membrane pores in the Knudsen diffusion manner. The mass transfer resistance of the oxygen is mainly the collision between the oxygen molecules and the walls of the membrane pores, the collision probability among the oxygen molecules is greatly reduced, and the oxygen passes through a flow channel in a turbulent flow manner, such that the oxygen permeation rate is gradually reduced. When the oxygen is close to the inner surface, the oxygen convects, permeates through the membrane pores in the viscous flow manner and mainly passes through the flow channel in a laminar flow manner. The oxygen permeation rate is gradually increased along with the gradual increase of the pore diameter of the membrane. When the wall thickness of the hollow fiber membrane is increased, the ratio of a viscous flow flowing path to a Knudsen diffusion path in the manner that the oxygen passes through the membrane pores is increased, namely the distance of the oxygen molecules permeating through the membrane pores in the viscous flow manner in the membrane is increased, the oxygen permeation rate is further increased, the total flow of the oxygen is increased, and the deoxidation efficiency of the hollow fiber membrane is further increased. The Knudsen diffusion refers to that when a gas diffuses in a porous solid, if the pore diameter is smaller than the mean free path of gas molecules, the gas molecules collide with pore walls much more frequently than between the gas molecules. The viscous flow refers to that the pore diameter of the membrane is far greater than the mean free path of the gas molecules and the collision probability among the gas molecules is far greater than that of the gas molecules and the pore walls of the membrane. The free path is the straight line path that a molecule travels between two successive collisions with other molecules. For individual molecules, the free path is sometimes long and sometimes short, but the free paths of a large number of molecules have a certain statistical law. The average of a large number of molecular free paths is called the mean free path.

The area rate of the air pores in the inner surface is 10%-30%. If the area rate of the air pores is too large, the tensile strength of the hollow fiber membrane is reduced and the service life of the hollow fiber membrane is further reduced. If the area rate of the air pores is smaller, the oxygen circulation channels are reduced and the deoxidation efficiency is further reduced. Meanwhile, when the membrane wall is thicker, the proper area ratio of the air pore in the inner surface provides enough gas circulation area, thereby avoiding the oxygen from being accumulated in the area close to the inner surface, increasing the mass transfer resistance and reducing the deoxidation efficiency. The thickness of the hollow fiber membrane in the present application is 45-65 μm. The proper ratio of the average outer diameter to the average inner diameter of the hollow fiber membrane enables the membrane to have a proper oxygen flow area and a proper inner cavity volume, and the oxygen to have a proper flow rate in the inner cavity. Meanwhile, the reduction of the surface area of the inner surface caused by over-thickness and smaller inner diameter of the hollow fiber membrane is avoided, such that the oxygen circulation channels are reduced, the resistance of oxygen diffusion is increased and the deoxidation efficiency is reduced. The reduction of the tensile strength and thus the reduction of the service life due to the thinness of the hollow fiber membrane can further be avoided. The present application has the proper air pore area ratio, membrane wall thickness, and ratio of average outer diameter to average inner diameter of the hollow fiber membrane, such that the oxygen circulation channels are increased and meanwhile, strong tensile strength is ensured.

Besides, since the outer surface of the hollow fiber membrane is a dense surface, the porosity is lower and the hydrophobicity is stronger, ultrapure water is avoided from entering the membrane through the pores in the outer surface, namely the contact area between the ultrapure water and the outer surface is small, thereby further reducing the dissolving-out amount of organic matters in the hollow fiber membrane. The TOC dissolving-out amount in the present application is less than or equal to 3 μg/L, preferably less than or equal to 0.5 μg/L. In addition, the blockage of the pores in the outer surface by the dissolved TOC is avoided, such that the oxygen has the better oxygen throughput and good deoxidation effect.

In conclusion, the hollow fiber membrane of the present application has proper thickness and the outer surface is a dense surface, such that the TOC dissolving-out amount is lower. Besides, the distance of the oxygen molecules in the membrane permeating through the membrane pores in the viscous flow manner is proper, thereby further improving the oxygen permeation rate. Meanwhile, the area ratio of the air pores in the inner surface is 10%-30% and the ratio of the average outer diameter to the average inner diameter of the hollow fiber membrane is 1.45-1.55, such that the oxygen has enough flow channels and proper inner cavity flow velocity, and the deoxidation efficiency of the hollow fiber membrane is greater than 80%. Meanwhile, the hollow fiber membrane is ensured to have a sufficiently great tensile strength.

Further, the inner surface is provided with a plurality of oval air pores, the major axis of each air pore is oriented to the length direction of the hollow fiber membrane, the minor axis of each air pore is oriented to the circumferential direction of the hollow fiber membrane, the average major axis of the air pores is 150-300 nm, the average minor axis of the air pores is 10-60 nm, and the degree of hollowness of the hollow fiber membrane is 35%-55%.

Under the action of pressure, the stress borne by the air pores is concentrated on the major axis. If the average major axis of the air pores is too long, the pores are easy to collapse; and if the average major axis of the air pores is shorter, the pore area of the air pores is reduced, the mass transfer resistance is increased, the oxygen permeation amount is reduced and the deoxidation efficiency is further reduced. The minor axis of the present application is oriented to the circumferential direction of the hollow fiber membrane, the ratio of the minor axis to the major axis of the oval is a shape ratio. When the shape ratio is closer to 1, the major axis and the minor axis of the oval both need to bear certain stress. If the average minor axis of the air pores is too long, the hollow fiber membrane bears more stress and is more likely to crack. The average major axis of the air pores is 150-300 nm and the average minor axis is 10-60 nm, such that the structure of the air pores is more stable and not likely to collapse or crack. Meanwhile, the circulation of the oxygen molecules in the membrane holes is increased, the oxygen permeation rate is further increased and the hollow fiber membrane has better deoxidation efficiency.

The degree of hollowness of the hollow fiber membrane in the present application is 35%-55%. It should be noted that the degree of hollowness is the percentage of the actual effective inner cavity area to the outer cross-sectional area and is calculated by formula 1:

$$W = \frac{{S}_{2}}{{S}_{1}} \times 100 \% \qquad Formula 1$$

W is the degree of hollowness in %, S₁ is the area of the outer cross section in mm²; and S₂ is the area of the effective cavity in mm².

If the degree of hollowness is greater, the effective membrane area is smaller, such that the porosity is reduced, the membrane is thinner and the fibers are more easily compressed and less easily processed, and meanwhile, the tensile strength of the membrane is reduced. Besides, when the membrane is under pressure, the cavity is easy to deform, thereby reducing the performance of the membrane; and if the degree of hollowness is smaller, namely the effective cavity area is smaller, the surface area of the inner surface is reduced, the oxygen circulation channels are reduced, the oxygen diffusion resistance is increased, and the deoxidation efficiency is further reduced. The hollow fiber membrane of the present application has the proper degree of hollowness, such that the membrane has stronger tensile strength and better deoxidation efficiency. Meanwhile, the hollow fiber membrane is resistant to compression and not likely to deform.

Preferably, the difference between the maximum thickness and the minimum thickness of the hollow fiber membrane is less than or equal to 5 μm, and the difference is less than or equal to 10% of the average thickness of the hollow fiber membrane; and the porosity of the hollow fiber membrane is 30%-50%, and 1.5-3.5 times of the area ratio of the air pores in the inner surface.

The difference between the maximum thickness and the minimum thickness of the hollow fiber membrane of the present application is less than or equal to 5 μm. It can be seen that the wall thickness of the hollow fiber membrane is uniform. If the difference is too large, the wall thickness of the hollow fiber membrane is not uniform, such that the gas passing manner in the hollow fiber membrane is disordered, the mass transfer resistance of the oxygen passing through the membrane is increased, the passing of the oxygen is not facilitated, the throughput of gas at all the parts of the hollow fiber membrane is not uniform and the deoxidation efficiency is further reduced. Meanwhile, the tensile strength at all the parts of the hollow fiber membrane is not uniform and the tensile strength of the hollow fiber membrane is further reduced. The porosity of the hollow fiber membrane in the present application is 30%-50%, such that more oxygen can pass through the pores in the viscous flow manner, the throughput of the oxygen is increased and meanwhile, the tensile strength of the membrane is ensured. If the porosity of the hollow fiber membrane is too large, the tensile strength of the membrane is easily reduced; and if the porosity of the hollow fiber membrane is smaller, the oxygen throughput of the membrane is reduced and the deoxidation efficiency is further reduced. The porosity of the hollow fiber membrane is 1.5-3.5 times of the area ratio of the air pores in the inner surface. If the times is too large, the porosity of the hollow fiber membrane is lower, the oxygen throughput is lower and the deoxidation efficiency is further reduced; and if the times is smaller, the porosity of the hollow fiber membrane is greater and the tensile strength of the membrane is reduced.

Furthermore, the average major axis of the air pores is 2-8 times of the average minor axis; and the difference between the maximum major axis and the minimum major axis of the air pores is 150-350 nm, and the difference between the maximum minor axis and the minimum minor axis of the air pores is 10-100 nm.

The size and the uniformity of the air pores in the air-permeable membrane directly influence the performance of the hollow fiber membrane. If the ratio of the average major axis to the average minor axis of the air pores is too large, the stress axially (in the length direction of the membrane) borne by the air pores is increased, the air pores are easy to collapse, and the deoxidation efficiency and the tensile strength of the membrane are further reduced; and if the ratio of the average major axis and the average minor axis of the air pores is smaller, the average pore area of the air pores is reduced, and the oxygen throughput and the deoxidation efficiency are further reduced. If the difference between the maximum major axis and the minimum major axis is greater, the axial distribution of the air pores in the hollow fiber membrane is not uniform. If the difference between the maximum minor axis and the minimum minor axis is greater, the circumferential distribution of the air pores in the hollow fiber membrane is not uniform. No matter the air pores are distributed nonuniformly in the axial direction or the circumferential direction of the hollow fiber membrane, the tensile strength of the hollow fiber membrane is not uniform and the hollow fiber membrane is prone to fracturing, thereby influencing the performance of the hollow fiber membrane. Meanwhile, the size distribution of the pore holes is not uniform, such that the throughput of the oxygen in the membrane is nonuniform, the mass transfer resistance of the oxygen in the flow channels is easily increased, the oxygen permeation rate is reduced, and the deoxidation efficiency is further reduced. The average major axis of the air pores of the present application is 2-8 times of the average minor axis; and the difference between the maximum major axis and the minimum major axis of the air pores is 150-350 nm, and the difference between the maximum minor axis and the minimum minor axis of the air pores is 10-100 nm, such that the membrane prepared in the present application has relatively uniform air pores and higher deoxidation efficiency and tensile strength.

Furthermore, in the circumferential direction of the hollow fiber membrane, a plurality of the air pores are regularly arranged to form an air permeable area for air permeability; the length direction of the air permeable area is consistent with the circumferential direction of the hollow fiber membrane; the width direction of the air permeable area is consistent with the length direction of the hollow fiber membrane; and the average length of the air permeable area is 400-1,100 nm and greater than the average width of the air permeable area.

A plurality of the air pores are regularly arranged to form an air permeable area. The hollow fiber membrane is provided with the plurality of air permeable areas. The average length of the air permeable area is greater than the average width of the air permeable area. The air permeable area is approximately oval and the average length is 400-1,100 nm. When the hollow fiber membrane bears pressure, the air permeable area has stability and is not likely to collapse, such that the structure of the hollow fiber membrane is more stable and is not likely to deform. If the average length of the air permeable area is too long, the hollow fiber membrane is likely to deform or collapse due to insufficient circumferential supporting strength and the performance of the membrane is further influenced; and if the average length of the air permeable area is smaller, the increase of a non-porous area is likely to be caused and the porosity is further reduced. The average length of the air permeable area is larger than the average width of the air permeable area so as to keep the integral tensile strength of the hollow fiber membrane and avoid the reduction of the tensile strength of the hollow fiber membrane in the length direction.

Furthermore, in the length direction of the hollow fiber membrane, the distance between two adjacent air permeable areas is a first distance, and the average length of the first distances is 100-350 nm; in the circumferential direction of the hollow fiber membrane, the distance between two adjacent air permeable areas is a second distance, and the average length of the second distances is 100-300 nm; the average length of the first distances is 2-3 times that of the second distances; the average distance between the adjacent air pores in the length direction of the air permeable areas is 20-70 nm; and the area ratio of the air pores of the air permeable areas is 25%-70% and the area ratio of the air pores of the air permeable areas is 20%-50% greater than that of the air pores in the inner surface.

The air permeable areas have the higher area ratio of the air pores, the distance between two adjacent air permeable areas in the length direction of the hollow fiber membrane is the first distance and the distance between two adjacent air permeable areas in the circumferential direction of the hollow fiber membrane is the second distance. The proper sizes of the first distance and the second distance have a supporting effect on the air permeable area. The hollow fiber membrane is prevented from collapsing or fracturing due to the higher area ratio of the air pores (the tensile strength of the hollow fiber membrane is reduced) when the membrane bears pressure. Besides, since the stress borne by the air pores is concentrated in the major axis, namely the stress borne by the air permeable area is concentrated in the width direction of the air permeable area, the stress borne by the hollow fiber membrane is concentrated in the length direction, such that the average length of the first distance should be greater in size to provide sufficient support. The size of the average length of the first distance of the present application is 2-3 times of the size of the average length of the second distance. If the times is greater, the porosity of the hollow fiber membrane is reduced; and if the times is smaller, when the hollow fiber membrane bears pressure, the supporting force of the first distance of the hollow fiber membrane is insufficient and the air permeable area is likely to collapse or fracture in the width direction.

Since the air permeable area is the main area of the inner surface through which gas permeates, a third distance is formed between the adjacent air pores in the length direction of the air permeable area. The average length of the third distance is 20-70 nm and reflects the number of the pores in the inner surface to a certain extent. When the average length of the third distance is too great, the number of the pores in a certain area of the inner surface is less, the degassing efficiency is inevitably influenced by the less pores. Meanwhile, the gas permeation resistance is greatly increased and the pressure loss in the degassing process is greatly increased. Besides, when the average length of the third distance is smaller, more pores will appear in a certain area of the inner surface (i.e. in this area, the area ratio of the pores is too great and the solid area ratio is too low), which is a great drawback. When an external force is applied, the pores are likely to collapse, such that the degassing membrane cannot continue to perform degassing and the service life is shorter. The area ratio of the pores in the air permeable area of the present application is greater, such that the membrane has higher degassing rate. But the area ratio of the pores in the air permeable area cannot be too great, otherwise, the risk of pore collapse exists and the service life is too short. The area ratio of the pores in the air permeable area is 30%-70% and the area ratio of the pores in the air permeable area is 20%-50% higher than that of the whole pores in the inner surface. Such area ratio of the pores further ensures that the hollow fiber membrane has the higher degassing rate and also has the stronger dimensional stability.

Furthermore, the outer surface is also provided with a plurality of crazing cracks and the width of each crack is less than or equal to 20 nm; and the surface energy of the outer surface is 15-40 mN/m.

The outer surface of the present application is further provided with a plurality of crazing cracks, such that the gas throughput of the outer surface is increased and the deoxidation efficiency is further increased. If the width of the crack is greater, when the pressure born by the hollow fiber membrane is greater, liquid is likely to penetrate through the crack and enter the membrane, and the service life of the membrane is further reduced. Therefore, when the width of the crack is less than or equal to 20 nm, the oxygen permeation amount of the outer surface can be increased and the liquid is ensured not to enter the membrane.

It should be noted that the surface energy is a measure of the breakdown of chemical bonds between molecules when creating a surface of a substance. If the surface energy of the outer surface is too great, the surface tension of the outer surface is greater and the barrier property of the outer surface to the liquid is reduced. When the outer surface of the hollow fiber membrane bears a greater pressure, the liquid is likely to permeate through the outer surface to enter the membrane, such that the gas-liquid separation effect of the air-permeable membrane is lost. If the surface energy is smaller, the surface tension of the outer surface is too small, the gas permeation amount is reduced and the deoxidation efficiency is further reduced. The surface energy of the outer surface of the present application is 15-40 mN/m, such that the outer surface has the proper barrier property, ensures the greater throughput of gas and meanwhile effectively prevents the liquid from permeating through the outer surface to enter the membrane.

Furthermore, the main body of the hollow fiber membrane is provided with a skin layer area and a porous area along the thickness direction of the membrane, and continuous fibers are in transition between the skin layer area and the porous area; one side of the skin layer area is an outer surface and one side of the porous area is an inner surface; and the thickness of the skin layer area is 0.5-4 μm, the thickness of the skin layer area accounts for 1%-8% of the thickness of the hollow fiber membrane, and the porosity of the skin layer area is less than or equal to 10%.

The thickness of the skin layer area is 0.5-4 μm. If the skin layer area is thinner, the tensile strength of the membrane is reduced. If the skin layer area is thicker, the oxygen permeation amount is reduced. Meanwhile, the Knudsen diffusion path of the oxygen in the membrane is prolonged, the mass transfer resistance of the oxygen is increased, the oxygen permeation rate is reduced and the deoxidation efficiency is further reduced. The thickness of the skin layer area of the present application accounts for 1%-8% of the thickness of the hollow fiber membrane, such that the hollow fiber membrane has the higher deoxidation efficiency and tensile strength. If the thickness of the skin layer area of the present application accounts for less than 1%-8% of the thickness of the hollow fiber membrane, the oxygen permeation amount of the hollow fiber membrane is reduced and the deoxidation efficiency is further reduced. If the thickness of the skin layer area of the present application accounts for greater than 1%-8% of the thickness of the hollow fiber membrane, the tensile strength of the hollow fiber membrane is reduced.

Furthermore, the average pore diameter of the porous area gradiently changes from the area close to one side of the inner surface to the area close to one side of the outer surface; and the change gradient of the average pore diameter of the porous area is 1.5-3 nm/μm, the porosity of the porous area is 40%-70%, and the diameter of the fibers of the porous area is 60-300 nm.

The porous area of the present application is in the gradient change and the change gradient of the average pore diameter is 1.5-3 nm/μm. It can be seen that the change gradient of the average pore diameter is relatively smooth, such that the oxygen always diffuses in the membrane at a higher diffusion rate. If the change gradient of the average pore diameter is greater, the diffusion manner of the oxygen in the membrane is mutated from the Knudsen diffusion to the viscous flow. The oxygen consumes a greater kinetic energy in the process of the mutation and the gas permeation rate is further reduced. The diameter of the fibers of the porous area of the present application is 60-300 nm, such that the porous area has the proper tensile strength and porosity. The porosity of the porous area of the present application is 40%-70%, such that the oxygen has more flow channels in the hollow fiber membrane to ensure the throughput of the oxygen.

A method for preparing the high-efficiency degassing polyolefin hollow fiber membrane according to any one of the above includes the following steps:
S1, spinning, namely melting and extruding polyolefin, and forming a semi-formed product with a hollow inner cavity under the action of a cavity-forming fluid, wherein the melt index of the polyolefin is 1-7 g/min@(Tm+20° C., 5 kg), the extrusion thickness of a die head is 1.8-2.2 mm and the flow velocity of the cavity-forming fluid of 0.01-0.05 ml/min; and the polyolefin is any one of PE, PP and PMP;
S2, pre-crystallizing, namely, cooling and pre-crystallizing the semi-formed product obtained in step S1 in an air-cooling manner to obtain a pre-crystallized semi-finished product;
S3, wind-cooling for crystallization, namely performing secondary cooling for crystallization on the pre-crystallized semi-finished product obtained in step S2 in a wind-cooling manner and rolling same to obtain a cooled semi-finished product;
S4, annealing for shaping, namely heat-shaping the cooled semi-finished product obtained in step S3 and cooling same to obtain a heat-shaped semi-finished product;
S5, twice cold-stretching for pore-forming, namely performing a first cold-stretching treatment on the heat-shaped semi-finished product obtained in step S4 at the rate of 10%-25%/min and the stretching ratio of 15%-25% to obtain a first cold-stretched semi-finished product; and performing a secondary cold-stretching treatment on the semi-finished product at the rate of 15%-30%/min and the stretching ratio of 5%-20% to obtain a secondary cold-stretched semi-finished product;
S6, heat-stretching for pore-expanding, namely heat-stretching the cold-stretched semi-finished product obtained in step S5 for pore-expanding to obtain a heat-stretched semi-finished product; and
S7, heat-shaping, namely performing a secondary heat-shaping treatment on the heat-stretched semi-finished product obtained in step S6 and cooling same to obtain a hollow fiber membrane.

In the present application, the polyolefin is extruded after being melted and meanwhile the cavity-forming fluid is introduced to form an unshaped semi-finished product, wherein the introduction of the cavity-forming fluid can effectively avoid the indent deformation of the semi-finished product. Then the semi-finished product is preliminarily shaped in the air-cooling manner to form the pre-crystallized semi-finished product. The pre-crystallized semi-finished product is cooled and crystallized in the wind-cooling manner which has the proper cooling temperature, cooling length and wind rate. The semi-finished product is crystallized, has the proper crystallinity and is rolled after reaching the proper rolling temperature to obtain the cooled semi-finished product. The cooled semi-finished product is annealed to eliminate internal defects. The cooled semi-finished product is subjected to twice cold-stretching treatments. Although the rates and the stretching ratios of the twice cold-stretching are close, the second cold-stretching is performed on the basis of the first cold-stretching, namely the twice cold-stretching is actually a process that the rate of the cold-stretching is continuously increased and the stretching ratio is continuously increased. If one-time cold-stretching is used, the tensile stress is likely to be too great and the stretching degrees of different lamellar crystals (including easily pulled lamellar crystals and difficultly pulled lamellar crystals) are different, such that the pore diameters of the prepared membrane are not uniform or the structure is collapsed. The twice cold-stretching is used in the present application. The tensile stress generated by the first cold-stretching at the stretching rate and the stretching ratio is smaller, such that the easily pulled lamellar crystals are firstly pulled apart. The second cold-stretching at the stretching rate and the stretching ratio is performed on the basis of the first cold-stretching so as to generate the greater tensile stress to pull apart the difficultly pulled lamellar crystals. Further, the molecular chain is loosened for enough time, such that the problems that microfiber ligaments are likely to be broken, the stretching size of the lamellar crystals is not uniform and the like are solved. Therefore, the prepared membrane has more uniform pore diameter and greater porosity. Meanwhile, the stress distribution of the twice stretching is more uniform, such that the walls of the prepared membrane are more uniform. The twice cold-stretching is used in the present application. Firstly, the first stretching is performed by using a small stress and then the secondary stretching is performed to improve the stretching stress. Therefore, the prepared membrane has the proper thickness, the polyolefin has the proper orientation degree, the crystallinity of the membrane is further increased and meanwhile the thickness of the membrane wall is more uniform.

The greater melt index value indicates the better processing fluidity of the material, such that the flow velocity of a melt is more uniform and the thickness of the membrane is more uniform. Otherwise, the smaller melt index value indicates the worse processing fluidity of the material. When the melt index is smaller, the obstruction of molecular chain arrangement is increased, the molecular chains diffuse, the activation energy required by a crystal phase structure is improved, the regular arrangement capacity of the molecular chains is reduced and thus the crystallinity is reduced. When the melt index is too large, the plasticity of the material is deteriorated and the material is difficult to shape. The proper melt index of the present application enables the prepared hollow fiber membrane to have the proper thickness and the polyolefin to have the greater crystallinity. The porosity of the hollow fiber membrane is increased so as to increase the distance of the oxygen molecules in the membrane to permeate through the membrane pores in the viscous flow manner. Meanwhile, the membrane has the good processing fluidity, such that the thickness of the membrane wall is more uniform, the processing efficiency of the raw material is improved, and the energy consumption and the production cost are reduced. The cavity-forming fluid of the present application is preferably nitrogen and has the proper flow velocity. If the flow velocity of the nitrogen is too great, the stress of the inner surface of the semi-finished product is too great, the regularity of the inner surface of the semi-finished product is reduced easily and the uniformity of the membrane wall is reduced; and if the flow velocity of the nitrogen is smaller, the supporting force required for forming the inner cavity of the semi-finished product cannot be achieved and the surface of the semi-finished product is easy to collapse. The proper flow velocity of the nitrogen enables the thickness of the membrane wall of the prepared membrane to be more uniform. The thickness of the semi-finished product extruded by the die head is 1.8-2.2 mm. If the thickness of the semi-finished product is too thick, the thickness of the membrane prepared by the twice cold-stretching is thicker and not uniform; and if the thickness of the semi-finished product is thinner, the membrane prepared by the twice stretching is thinner and the tensile strength is reduced.

The twice cold-stretching of the present application performs stretching for pore-forming by using a rapid cold-stretching manner so as to obtain the cold-stretched semi-finished product. After the cold-stretching for pore-forming, the formed pores can rebound and shrink, such that the average pore diameter is reduced and the thickness is increased. Therefore, the cold-stretched semi-finished product is subjected to the heat-stretching pore-expanding treatment, such that the semi-finished product has the proper average pore diameter and the proper gas throughput. Finally, the average pore diameter is heat-shaped. The formed pores and the membrane thickness are shaped at the proper temperature and time. The main function of the cold-stretching is to pull apart the lamellar crystals and form the initial microfiber ligament structure. However, the main function of the heat-stretching is to expand the micropores created during the cold-stretching stage, the separation degree of the lamellar crystals is increased and the microfiber ligament structure is more stable.

Furthermore, in step S1, the extrusion temperature of the die head is (Tm+10)−(Tm+70)° C., the melting point of the polyolefin is Tm, the length-diameter ratio of the die head is 2-5, the molecular weight of the polyolefin is 60,000-100,000, and the molecular weight distribution index of the polyolefin is 1-5.

The extrusion temperature of the die head of the present application is 10-40° C. above the melting point of the polyolefin, preferably, 15-38° C. above the melting point of the polyolefin. The flow viscosity of the polymer melt is obviously influenced by the temperature and the viscosity generally decreases with the increase of the temperature. When the extrusion temperature of the die head is too low, the viscosity of the polyolefin is increased, the resistance of the extrusion die head is increased, the extrusion amount of the polyolefin is unstable and the thickness of the membrane is further unstable. Meanwhile, the stress borne by the melt is reduced, such that the orientation degree of the fibers is reduced, the crystallinity of the membrane is further reduced and the tensile strength and the oxygen permeation efficiency of the membrane are reduced. When the extrusion temperature of the die head is too high, the polyolefin is easily subjected to thermal degradation, the mechanical property is obviously reduced and the mechanical performance of the membrane is further reduced. Besides, the mobility of the chain segments of the polymer molecules is further easily increased, the fluidity of the melt is increased, its viscosity is reduced, the thickness of the prepared membrane is reduced and the gas throughput is further influenced. The proper extrusion temperature of the die head and the melt index of the present application enable the thickness of the prepared membrane to be more uniform, and ensure good porosity and stronger mechanical performance. Meanwhile, in the proper range of the extrusion temperature of the die head, when the extrusion temperature of the die head is higher, an extremely small part of the polyolefin is likely to decompose, such that the outer surface of the prepared membrane has crazing cracks.

The length-diameter ratio of the die head is the ratio of the effective length of a screw to the diameter of the screw. When the major axis is smaller, the free volume of an extruder is reduced and the outlet expansion effect is larger, such that the shearing force borne by macromolecules in the pore channels is smaller, the formed regular structure is fewer, the crystallinity is reduced, the number of the pores of the prepared membrane is reduced and the porosity of the membrane is reduced. Meanwhile, the phenomenon of orifice swelling generated in the spinning process cannot be effectively solved and the thickness of the membrane and the mechanical performance of the prepared membrane are further influenced. The phenomenon of the orifice swelling, also known as the barus effect, refers to that when a high polymer fluid is extruded from a small orifice, capillary or slit, the diameter or thickness of an extrudate will be obviously greater than the size of the orifice. When the length-diameter ratio is too great, the pressure applied by the screw is too great and the performance of the prepared membrane is influenced. The proper length-diameter ratio of the die head of the present application enables the membrane to have the proper crystallinity and the thickness of the membrane wall to be uniform.

Different molecular weights and molecular weight distributions have certain influence on the crystallinity and the size of crystal nuclei. It can be known from the polydispersity of the molecular weights that obvious interaction exists between high- and low-molecular-weight components. When the molecular weight distribution is wider, the interaction between the high- and low-molecular-weight components is increased. Since the crystallization rates of the high- and low-molecular-weight components are different, the low-molecular-weight components have the high crystallization speed and are crystallized first, and the first crystallized high-molecular chains freeze the uncrystallized high-molecular chains, thereby reducing the crystallinity. Meanwhile, the rapid crystallization of the low-molecular-weight components limits the growth of the crystal nuclei, such that the size of the crystal nuclei is reduced, the formed pores are smaller and the gas throughput is further reduced. If the molecular weight distribution becomes narrow, the interaction between the high- and low-molecular-weight components is reduced, and the components are crystallized at the similar speed, which is beneficial to the generation of the crystal nuclei and enables the distribution of the crystal nuclei to tend to be uniform. Therefore, the prepared hollow fiber membrane has more uniform pore distribution, proper porosity and better mechanical performance, and proper gas throughput and greater tensile strength.

Therefore, the polyolefin in the present application has proper molecular weight of 60,000-100,000 and narrow molecular weight distribution of 1-5, such that the crystal nucleus distribution tends to be uniform in the process for preparing the hollow fiber membrane, the pore distribution of the prepared membrane is more uniform, and the membrane has the proper porosity and better mechanical performance, and proper gas throughput and greater tensile strength.

Furthermore, in step S1, when the polyolefin is PP, the isotacticity of the PP is greater than 99%, the crystallinity is 45%-75% and the melt index is 2-5 g/min@(190° C., 5 kg); or when the polyolefin is PE, the PE is mLLDPE, the density of the mLLDPE is 0.91-0.93 g/cm³, the molecular weight distribution index is 2-2.5 and the degree of branching is 0.1-0.4; or when the polyolefin is PMP, the Vicat softening point of the PMP is 160-170° C.

The polyolefin of the present application is preferably the PP and the isotacticity of the PP is greater than 99%. The isotacticity refers to the total percentage of isotactic and syndiotactic polymers in all the polymer molecules. The PP with the greater isotacticity has better symmetry. The high polymers free of branched chains or with few branched chains or small volume of side groups or large intermolecular force are easy to be mutually close, such that the PP is more easily crystallized and further has better crystallinity in the process of preparing the hollow fiber membrane. The PP of the present application has the proper crystallinity and melt index, such that the PP has the good processing fluidity, the processing efficiency of the raw material is improved, and the energy consumption and the production cost are reduced. Meanwhile, the thickness of the prepared membrane is more uniform and the pores formed in the membrane are more uniform, such that the permeation rate of the oxygen passing through the membrane pores is more uniform and the membrane has the better gas throughput.

When the polyolefin in the application is PE, preferably mLLDPE with the relatively regular molecular chain structure, and the degree of branching of the mLLDPE is greater, more short branched chains in the molecular chain of the mLLDPE indicates that the steric hindrance for molecular motion and ordered arrangement is greater, and the crystallinity is lower. The mLLDPE of the present application has the proper degree of branching and thus has the greater crystallinity. When the molecular weight distribution of the mLLDPE is narrow, the intermolecular force is greater, the tight stacking of the molecular chains is facilitated, the movement speed of each chain segment is closer and the crystallinity thereof is improved. The mLLDPE of the present application has the proper molecular weight distribution index and thus has the greater crystallinity. The mLLDPE of the present application has the density of 0.91-0.93 g/cm³, wherein the density is determined by the concentration of comonomers for copolymerization in a polyolefin chain. The concentration of the comonomers for copolymerization controls the number of the short branched chains (the length of which depends on the types of the comonomers) and thus controls the resin density. The lack of long branched chains in the mLLDPE keeps the polymer from entanglement, avoiding the formation of the pores with too great pore diameter. In conclusion, the hollow fiber membrane prepared from the mLLDPE in the present application has the higher crystallinity, uniform pore diameter distribution and smaller average pore diameter, such that the hollow fiber membrane has higher porosity and the channels for the oxygen circulating in the membrane are increased so as to improve the permeation rate of the oxygen in the membrane, improve the deoxidation efficiency and meanwhile ensure the mechanical strength. The degree of branching refers to the density of branch points in the high-molecular chains or the length of the chain segment between adjacent branched chains or the relative molecular weight of the chain segment.

When the polyolefin is PMP in the present application, the Vicat softening point of the PMP is 160-170° C., such that the hollow fiber membrane has the good dimensional stability and small thermal deformation when being heated, namely the hollow fiber membrane has the good heat resistance and deformation resistance, large rigidity and high modulus.

Furthermore, in step S2, the temperature of the air-cooling is lower than the temperature of the die head extruding by 110-220° C. and the air-cooling distance is 30-1,000 mm.

The extrusion temperature of the die head is higher than the melting point of the polyolefin so as not to influence the regularity of the surface and avoid crystallization caused by too low temperature from influencing the crystallinity in the subsequent steps. Therefore, the polyolefin is extruded in a molten state to form a semi-formed product and the semi-formed product is cooled in the air-cooling manner to shape the semi-formed product. When the temperature of the air-cooling is too low, the semi-formed product is directly crystallized in the shaping process, such that the crystallization is not uniform, the pore diameter in the membrane is not uniform and the permeation rate of the oxygen in the membrane is further reduced. When the temperature of the air-cooling is too high, the semi-finished product is insufficiently shaped and the surface is easy to dent in the wind-cooling for crystallization, such that the thickness of the membrane wall is not uniform and the performance of the membrane is further influenced. If the air-cooling distance of the semi-finished product is too long, the material in a molten state is easy to shake under the influence of external factors, the thickness of the membrane is also changed and thus the uniformity of the thickness of the membrane wall is poor. If the air-cooling distance of the semi-finished product is short, the shaping is insufficient and the uniformity of the membrane wall of the prepared membrane is poor.

The proper air-cooling temperature and air-cooling distance are used in the present application, such that the semi-finished product is not crystallized in the air-cooling process, the shaping is complete and meanwhile the nonuniformity of the thickness of the membrane wall of the prepared membrane is avoided.

Furthermore, in step S3, the wind-cooling length of the pre-crystallized semi-finished product is 4-8 m, the temperature of the wind-cooling is 40-70° C. and the airflow velocity in the process of the wind-cooling for crystallization is 30-60 m/min.

It should be noted that when the temperature of the wind-cooling is too high, the outer surface cannot be rapidly cooled, the dense surface cannot be further formed and the liquid is likely to permeate the hollow fiber membrane, such that the effect of degassing the liquid is lost. When the temperature of the wind-cooling is too low, the area rapidly cooled in the membrane thickness direction increases, and the thickness of the skin layer further increases, thereby reducing the gas throughput of the hollow fiber membrane. The present application has the proper wind-cooling temperature, such that the prepared hollow fiber membrane has the higher gas throughput and higher mechanical strength.

The outer surface of the hollow fiber membrane is rapidly cooled by the proper cooling temperature of the present application, such that the outer surface forms a dense surface and is provided with a skin layer area. However, the inner surface is still in a high-temperature state. The hollow fiber membrane is cooled to the proper length by wind-cooling, the temperature of the inner surface is reduced to the temperature capable of being rolled in a reasonable length range, and the process cost is saved.

The relative velocity of the airflow and the pre-crystallized semi-finished product in the wind-cooling for crystallization is 30-60 m/min. If the relative velocity is too high, the outer surface is easy to collapse, such that the uniformity of the membrane wall of the membrane is poor; and if the relative velocity is too slow, the cooling speed is too slow, and the outer surface cannot form a dense surface, thereby influencing the performance of the membrane. The proper relative velocity of the present application enables the outer surface of the membrane to form the dense surface and have proper gas throughput and mechanical performance.

Furthermore, in step S5, the temperature of the first cold-stretching is 25-72° C. higher than the glass transition temperature of the polyolefin and the temperature of the second cold-stretching is 35-80° C. higher than the glass transition temperature of the polyolefin.

Each cold-stretching temperature of the present application is higher than the glass transition temperature of the polyolefin. When the cold-stretching temperature is higher, agglomeration is easy to occur between adjacent crystal nuclei, such that the pore size and the pore distribution of the hollow fiber membrane are not uniform; and when the cold-stretching temperature is lower and the fiber temperature between the adjacent crystal nuclei is lower, the hollow fiber membrane lacks elasticity and is fractured easily, the performance of the membrane is further influenced, the mechanical strength is reduced and the degassing effect of the membrane is influenced. The first cold-stretching mainly firstly pulls apart the easily pulled lamellar crystals, and therefore, the temperature of the first cold-stretching is not too high easily so as to avoid the non-uniform stretching of the lamellar crystals; and the temperature of the secondary cold-stretching is higher than the temperature of the first cold-stretching so as to pull apart the difficultly pulled lamellar crystals. Meanwhile, the problem that the pore sizes and the pore distribution of the hollow fiber membrane due to overhigh secondary cold-stretching temperature is avoided. The present application has the proper first cold-stretching temperature and secondary cold-stretching temperature, such that the prepared hollow fiber membrane has the proper average pore diameter, uniform pore distribution and stronger tensile strength, and further good gas throughput.

Furthermore, the temperature of the heat-stretching in step S6 is at least 60-103° C. higher than the temperature of the first cold-stretching in step S5; the rate of the heat-stretching is 10%-30% of that of the first cold-stretching; and the stretching ratio of the heat-stretching is 2-7 times of that of the first cold-stretching.

When the temperature of the heat-stretching is higher, due to the emergence of thermally induced crystallization and tensile stress induced crystallization, the fibers rapidly crystallize, such that macromolecular chain segments cannot fully be stretched along the stretching direction. Meanwhile, the polymer molecular chains are fractured at high temperature, the effect of pore-expanding cannot be reached and the tensile strength of the hollow fiber membrane is reduced. When the heat-stretching temperature is lower, the temperature of free motion of the polymer macromolecular chain segments cannot be reached, such that the semi-finished product has the lower elasticity, the stretching is insufficient, or the fibers are fractured in the stretching process, and the pore-expanding effect cannot be reached. The heat-stretching is performed in a multi-section, slow-stretching and pore-expanding manner, preferably 5 times of the heat-stretching are performed. Besides, preferably, the heat-stretching speed is 10% of the first cold-stretching speed. The rapid cold-stretching is performed at the proper speed, such that the tensile fracture caused by the over-high speed can be avoided and the crystal nuclei can be rapidly fractured so as to form the pores more uniformly. The present application has the proper heat-stretching temperature and the heat-stretching temperature is at least 60-103° C. higher than the first cold-stretching temperature so as to reach an ideal effect of stretching for pore-expanding. Meanwhile, the hollow fiber membrane has higher tensile strength, greater gas throughput and good filtration effect.

When the heat-stretching rate is too low (it is understood that the so-called heat-stretching rate is characterized by the multiplying power of the cold-stretching rate on the basis of the determined cold-stretching rate), the tensile stress has enough time to act on each area. At this time, the molecular chains of the lamellar crystals and the molecular chains at the boundaries of the lamellar crystals and the amorphous regions have enough time to relax and be pulled out, such that part of the lamellar crystals are converted into the microfiber ligaments, the structures of the microfiber ligaments are too many and too structures of the lamellar crystals are too few, resulting in the deterioration of the microporous structure. When the heat-stretching rate is too high, the molecular chains with nonuniform tensile stress distribution and longer relaxation time cannot be converted in time, and finally only partial molecular chains with shorter relaxation time are converted into the microfiber ligament structure. Besides, the molecular chains at the boundaries of the lamellar crystals and the amorphous regions are easily over-stretched, such that the generated microporous structure is blocked, micropores are closed, and the microporous structure is deteriorated. The heat-stretching in the present application has the proper stretching rate, such that the hollow fiber membrane has more structures of the lamellar crystals and greater porosity in the preparation process, the gas throughput is further increased, and meanwhile the gas permeation rate is increased.

The stretching ratio refers to the ratio of the length of the fibers after the stretching to the length before the stretching. When the stretching ratio is higher, the tensile stress is higher and the original ordered crystalline regions of the fibers are damaged by the overhigh tensile stress, such that the crystallinity of the fibers is reduced. When the stretching ratio is lower, the expected membrane thickness and pore diameter cannot be achieved. The stretching ratio of the heat-stretching of the present application is 2-7 times of that of the first cold-stretching, such that the prepared hollow fiber membrane has the proper membrane thickness and pore diameter without influencing the crystallinity in the preparation process of the hollow fiber membrane.

The cold-stretching and the heat-stretching are mutually related and mutually influenced processes. The process parameters of both, such as temperature, stretching rate, stretching ratio and the like, have higher degree of relevancy, but the two processes are not isolated. When the process parameters are adjusted, the whole process parameters of both must be uniformly adjusted.

Furthermore, in step S4, the annealing for shaping reduces the temperature to 75-150° C. and is performed for 20-50 min.

In step S7, the temperature of the heat-shaping is 5-30° C. higher than the annealing temperature; and the heat-shaping is performed for 0.5-3 min.

It should be noted that the above definition can make the inner layers of the fibers have higher crystallinity, and good crystal regularity and orientation degree after annealing for shaping, such that during the stretching for pore-forming, a good pore structure can be obtained. Besides, during the heat-shaping, the stress residue existing in the inner layers of the fibers can be well eliminated, such that the fibers and the microporous structures in the fibers have high stability. With regard to the dense surfaces of the fibers, the specific temperature of annealing for shaping can reduce the crystallinity and crystal orientation degree and regularity of the dense surface, such that the possibility of generating the microporous structure in the dense surface in the process of stretching for pore-forming is reduced. Besides, during the heat-shaping, the higher temperature can eliminate the defect of the dense surface, further promote the crystallization behavior of the dense surface, improve the crystallinity of the dense surface and thus improve the mechanical performance of the dense surface.

Since the crystallinity, crystal form, regularity and the like of the fibers after the annealing for shaping all have great influence on the microporous structure of the fibers, the process parameters of the annealing for shaping and the heat-shaping are also related, Different lamellar crystal thickness, different sizes of the microfiber ligaments and the like have different process parameters of the heat-shaping.

The present application further provides use of the high-efficiency degassing polyolefin hollow fiber membrane according to any one of the above, wherein the polyolefin is PP, the hollow fiber membrane is used for removing oxygen in ultrapure water, the oxygen permeation rate of the hollow fiber membrane is 15-30 L/(min·bar·m²), the tensile strength of the hollow fiber membrane is greater than or equal to 150 CN, and the elongation at break of the hollow fiber membrane is 30%-150%.

The hollow fiber membrane prepared from the polyolefin is mainly used for removing oxygen in ultrapure water, has a greater permeation rate which can reach 15-30 L/(min·bar·m²). Meanwhile, the hollow fiber membrane has greater tensile strength greater than or equal to 150 CN and the elongation at break of 30%-150%, such that the prepared hollow fiber membrane has higher oxygen permeation rate, has the deoxidation efficiency greater than 80% and meanwhile has the higher tensile strength.

The application can bring the following beneficial effects: the hollow fiber membrane provided by the present application has the proper thickness, more uniform wall thickness and meanwhile greater crystallinity and porosity, so as to increase flow channels of the oxygen in the membrane and the permeation rate of the oxygen in the membrane, and enables the hollow fiber membrane to have higher deoxidation efficiency and meanwhile have greater tensile strength.

### BRIEF DESCRIPTION OF THE DRAWINGS

The accompanying drawings described here are provided for further understanding of the present application, and constitute a part of the present application. The exemplary embodiments and illustrations thereof of the present application are intended to explain the present application, but do not constitute inappropriate limitations to the present application. In the drawings:

FIG. 1 is a scanning electron microscope (SEM) image of the inner surface of the hollow fiber membrane obtained by preparation of example 4, wherein the amplification factor is 10,000×;

FIG. 2 is a scanning electron microscope (SEM) image of the inner surface of the hollow fiber membrane obtained by preparation of example 4, wherein the amplification factor is 20,000×;

FIG. 3 is a scanning electron microscope (SEM) image of the outer surface of the hollow fiber membrane obtained by preparation of example 4, wherein the amplification factor is 20,000×; and

FIG. 4 is a schematic diagram of an apparatus for a deoxidation efficiency test of the present application.

Reference numerals: 1. air permeable area; 2. second distance; and 3. first distance.

### DETAILED DESCRIPTION OF THE EMBODIMENTS

The present disclosure is further described in detail below with reference to the accompanying drawings and examples.

In the following examples, raw materials and equipment for preparing hollow fiber membranes are commercially available, unless otherwise specified. The structural morphologies of the filter membranes are characterized by using a scanning electron microscope with the model of S-5500 provided by the Hitachi company.

Example 1 provided a method for preparing a degassing hollow fiber membrane, specifically including the following steps:
S1, spinning, namely PP was melted and extruded to form a semi-formed product with a hollow inner cavity under the action of nitrogen, wherein the flow velocity of the nitrogen was 0.03 ml/min, the melt index of the PP was 4.5 g/min@(190° C., 5 kg), the extrusion thickness of a die head was 1.8 mm, the extrusion temperature of the die head was 210° C., the length-diameter ratio of the die head was 3, the molecular weight of the PP was 85,000, the molecular weight distribution index of the PP was 4.5, the isotacticity of the PP was greater than 99% and the crystallinity was 50%;
S2, pre-crystallizing, namely, the semi-formed product obtained in step S1 was cooled and pre-crystallized in an air-cooling manner to obtain a pre-crystallized semi-finished product, wherein the temperature of the air-cooling was 100° C. and the air-cooling distance of the semi-finished product was 500 mm;
S3, wind-cooling for crystallization, namely secondary cooling for crystallization was performed on the pre-crystallized semi-finished product obtained in step S2 in a wind-cooling manner and the semi-finished product was rolled to obtain a cooled semi-finished product, wherein the wind-cooling length of the pre-crystallized semi-finished product was 4.5 m, the temperature of the wind-cooling was 65° C. and the airflow velocity in the process of the wind-cooling for crystallization was 55 m/min;
S4, annealing for shaping, namely the cooled semi-finished product obtained in step S3 was heat-shaped and cooled to obtain a heat-shaped semi-finished product, wherein the annealing for shaping reduced the temperature to 90° C. and was performed for 48 min;
S5, twice cold-stretching for pore-forming, namely a first cold-stretching treatment was performed on the heat-shaped semi-finished product obtained in step S4 at the rate of 15%/min and the stretching ratio of 25% to obtain a first cold-stretched semi-finished product; and a secondary cold-stretching treatment was performed on the semi-finished product at the rate of 20%/min and the stretching ratio of 10% to obtain a secondary cold-stretched semi-finished product, wherein the temperature of the first cold-stretching was 30° C. and the temperature of the secondary cold-stretching was 20° C.;
S6, heat-stretching for pore-expanding, namely the cold-stretched semi-finished product obtained in step S5 was heat-stretched for pore-expanding to obtain a heat-stretched semi-finished product, wherein the temperature of the heat-stretching was 100° C., the rate of the heat-stretching was 15% of that of the first cold-stretching and the stretching ratio of the heat-stretching was 6.5 times of that of the first cold-stretching; and
S7, heat-shaping, namely a secondary heat-shaping treatment was performed on the heat-stretched semi-finished product obtained in step S6 and cooled to obtain a hollow fiber membrane, wherein the temperature of the heat-shaping was 100° C. and the heat-shaping was performed for 2 min.

Example 2 provided a method for preparing a degassing hollow fiber membrane, specifically including the following steps:
S1, spinning, namely PP was melted and extruded to form a semi-formed product with a hollow inner cavity under the action of nitrogen, wherein the flow velocity of the nitrogen was 0.02 ml/min, the melt index of the PP was 2.5 g/min@(190° C., 5 kg), the extrusion thickness of a die head was 2 mm, the extrusion temperature of the die head was 180° C., the length-diameter ratio of the die head was 4, the molecular weight of the PP was 65,000, the molecular weight distribution index of the PP was 0.5, the isotacticity of the PP was greater than 99% and the crystallinity was 65%;
S2, pre-crystallizing, namely, the semi-formed product obtained in step S1 was cooled and pre-crystallized in an air-cooling manner to obtain a pre-crystallized semi-finished product, wherein the temperature of the air-cooling was 30° C. and the air-cooling distance of the semi-finished product was 850 mm;
S3, wind-cooling for crystallization, namely secondary cooling for crystallization was performed on the pre-crystallized semi-finished product obtained in step S2 in a wind-cooling manner and the semi-finished product was rolled to obtain a cooled semi-finished product, wherein the wind-cooling length of the pre-crystallized semi-finished product was 7.5 m, the temperature of the wind-cooling was 45° C. and the airflow velocity in the process of the wind-cooling for crystallization was 35 m/min;
S4, annealing for shaping, namely the cooled semi-finished product obtained in step S3 was heat-shaped and cooled to obtain a heat-shaped semi-finished product, wherein the annealing for shaping reduced the temperature to 135° C. and was performed for 25 min;
S5, twice cold-stretching for pore-forming, namely a first cold-stretching treatment was performed on the heat-shaped semi-finished product obtained in step S4 at the rate of 23%/min and the stretching ratio of 18% to obtain a first cold-stretched semi-finished product; and a secondary cold-stretching treatment was performed on the semi-finished product at the rate of 16%/min and the stretching ratio of 15% to obtain a secondary cold-stretched semi-finished product, wherein the temperature of the first cold-stretching was 10° C. and the temperature of the secondary cold-stretching was 50° C.;
S6, heat-stretching for pore-expanding, namely the cold-stretched semi-finished product obtained in step S5 was heat-stretched for pore-expanding to obtain a heat-stretched semi-finished product, wherein the temperature of the heat-stretching was 95° C., the rate of the heat-stretching was 25% of that of the first cold-stretching and the stretching ratio of the heat-stretching was 2.5 times of that of the first cold-stretching; and
S7, heat-shaping, namely a secondary heat-shaping treatment was performed on the heat-stretched semi-finished product obtained in step S6 and cooled to obtain a hollow fiber membrane, wherein the temperature of the heat-shaping was 140° C. and the heat-shaping was performed for 0.5 min.

Example 3 provided a method for preparing a degassing hollow fiber membrane, specifically including the following steps:
S1, spinning, namely mLLDPE was melted and extruded to form a semi-formed product with a hollow inner cavity under the action of nitrogen, wherein the flow velocity of the nitrogen was 0.04 ml/min, the melt index of the mLLDPE was 4.5 g/min@(130° C., 5 kg), the extrusion thickness of a die head was 2.2 mm, the extrusion temperature of the die head was 180° C., the length-diameter ratio of the die head was 2.5, the molecular weight of the mLLDPE was 65,000, the molecular weight distribution index of the mLLDPE was 2.2, the density of the mLLDPE was 0.91 g/cm³ and the degree of branching was 0.35;
S2, pre-crystallizing, namely, the semi-formed product obtained in step S1 was cooled and pre-crystallized in an air-cooling manner to obtain a pre-crystallized semi-finished product, wherein the temperature of the air-cooling was 30° C. and the air-cooling distance of the semi-finished product was 1,500 mm;
S3, wind-cooling for crystallization, namely secondary cooling for crystallization was performed on the pre-crystallized semi-finished product obtained in step S2 in a wind-cooling manner and the semi-finished product was rolled to obtain a cooled semi-finished product, wherein the wind-cooling length of the pre-crystallized semi-finished product was 6 m, the temperature of the wind-cooling was 55° C. and the airflow velocity in the process of the wind-cooling for crystallization was 40 m/min;
S4, annealing for shaping, namely the cooled semi-finished product obtained in step S3 was heat-shaped and cooled to obtain a heat-shaped semi-finished product, wherein the annealing for shaping reduced the temperature to 100° C. and was performed for 35 min;
S5, twice cold-stretching for pore-forming, namely a first cold-stretching treatment was performed on the heat-shaped semi-finished product obtained in step S4 at the rate of 18%/min and the stretching ratio of 20% to obtain a first cold-stretched semi-finished product; and a secondary cold-stretching treatment was performed on the semi-finished product at the rate of 25%/min and the stretching ratio of 10% to obtain a secondary cold-stretched semi-finished product, wherein the temperature of the first cold-stretching was −5° C. and the temperature of the secondary cold-stretching was 8° C.;
S6, heat-stretching for pore-expanding, namely the cold-stretched semi-finished product obtained in step S5 was heat-stretched for pore-expanding to obtain a heat-stretched semi-finished product, wherein the temperature of the heat-stretching was 75° C., the rate of the heat-stretching was 10% of that of the first cold-stretching and the stretching ratio of the heat-stretching was 4.5 times of that of the first cold-stretching; and
S7, heat-shaping, namely a secondary heat-shaping treatment was performed on the heat-stretched semi-finished product obtained in step S6 and cooled to obtain a hollow fiber membrane, wherein the temperature of the heat-shaping was 110° C. higher than the annealing temperature and the heat-shaping was performed for 1 min.

Example 4 provided a method for preparing a degassing hollow fiber membrane, specifically including the following steps:
S1, spinning, namely PP was melted and extruded to form a semi-formed product with a hollow inner cavity under the action of nitrogen, wherein the flow velocity of the nitrogen was 0.035 ml/min, the melt index of the PP was 3 g/min@(190° C., 5 kg), the extrusion thickness of a die head was 1.9 mm, the extrusion temperature of the die head was 260° C., the length-diameter ratio of the die head was 4.5, the molecular weight of the PP was 80,000, the molecular weight distribution index of the PP was 2, the isotacticity of the PP was greater than 99% and the crystallinity was 60%;
S2, pre-crystallizing, namely, the semi-formed product obtained in step S1 was cooled and pre-crystallized in an air-cooling manner to obtain a pre-crystallized semi-finished product, wherein the temperature of the air-cooling was 60° C. and the air-cooling distance of the semi-finished product was 600 mm;
S3, wind-cooling for crystallization, namely secondary cooling for crystallization was performed on the pre-crystallized semi-finished product obtained in step S2 in a wind-cooling manner and the semi-finished product was rolled to obtain a cooled semi-finished product, wherein the wind-cooling length of the pre-crystallized semi-finished product was 5 m, the temperature of the wind-cooling was 50° C. and the airflow velocity in the process of the wind-cooling for crystallization was 50 m/min;
S4, annealing for shaping, namely the cooled semi-finished product obtained in step S3 was heat-shaped and cooled to obtain a heat-shaped semi-finished product, wherein the annealing for shaping reduced the temperature to 110° C. and was performed for 40 min;
S5, twice cold-stretching for pore-forming, namely a first cold-stretching treatment was performed on the heat-shaped semi-finished product obtained in step S4 at the rate of 12%/min and the stretching ratio of 23% to obtain a first cold-stretched semi-finished product; and a secondary cold-stretching treatment was performed on the semi-finished product at the rate of 28%/min and the stretching ratio of 7% to obtain a secondary cold-stretched semi-finished product, wherein the temperature of the first cold-stretching was 50° C. and the temperature of the secondary cold-stretching was 30° C.;
S6, heat-stretching for hole-expanding, namely the cold-stretched semi-finished product obtained in step S5 was heat-stretched for hole-expanding to obtain a heat-stretched semi-finished product, wherein the temperature of the heat-stretching was 110° C., the rate of the heat-stretching was 20% of that of the first cold-stretching and the stretching ratio of the heat-stretching was 5 times of that of the first cold-stretching; and
S7, heat-shaping, namely a secondary heat-shaping treatment was performed on the heat-stretched semi-finished product obtained in step S6 and cooled to obtain a hollow fiber membrane, wherein the temperature of the heat-shaping was 130° C. and the heat-shaping was performed for 2.5 min.

Example 5 provided a method for preparing a degassing hollow fiber membrane, specifically including the following steps:
S1, spinning, namely PMP was melted and extruded to form a semi-formed product with a hollow inner cavity under the action of nitrogen, wherein the flow velocity of the nitrogen was 0.015 ml/min, the melt index of the PMP was 3.5 g/min@(190° C., 5 kg), the extrusion thickness of a die head was 2.1 mm, the extrusion temperature of the die head was 270° C., the length-diameter ratio of the die head was 4.5, the molecular weight of the PMP was 98,000, the molecular weight distribution index of the PMP was 3 and the crystallinity was 55%;
S2, pre-crystallizing, namely, the semi-formed product obtained in step S1 was cooled and pre-crystallized in an air-cooling manner to obtain a pre-crystallized semi-finished product, wherein the temperature of the air-cooling was 50° C. and the air-cooling distance of the semi-finished product was 200 mm;
S3, wind-cooling for crystallization, namely secondary cooling for crystallization was performed on the pre-crystallized semi-finished product obtained in step S2 in a wind-cooling manner and the semi-finished product was rolled to obtain a cooled semi-finished product, wherein the wind-cooling length of the pre-crystallized semi-finished product was 5.5 m, the temperature of the wind-cooling was 60° C. and the airflow velocity in the process of the wind-cooling for crystallization was 45 m/min;
S4, annealing for shaping, namely the cooled semi-finished product obtained in step S3 was heat-shaped and cooled to obtain a heat-shaped semi-finished product, wherein the annealing for shaping reduced the temperature to 145° C. and was performed for 30 min;
S5, twice cold-stretching for pore-forming, namely a first cold-stretching treatment was performed on the heat-shaped semi-finished product obtained in step S4 at the rate of 20%/min and the stretching ratio of 15% to obtain a first cold-stretched semi-finished product; and a secondary cold-stretching treatment was performed on the semi-finished product at the rate of 19%/min and the stretching ratio of 20% to obtain a secondary cold-stretched semi-finished product, wherein the temperature of the first cold-stretching was 55° C. and the temperature of the secondary cold-stretching was 65° C.;
S6, heat-stretching for pore-expanding, namely the cold-stretched semi-finished product obtained in step S5 was heat-stretched for pore-expanding to obtain a heat-stretched semi-finished product, wherein the temperature of the heat-stretching was 125° C., the rate of the heat-stretching was 20% of that of the first cold-stretching and the stretching ratio of the heat-stretching was 3 times of that of the first cold-stretching; and
S7, heat-shaping, namely a secondary heat-shaping treatment was performed on the heat-stretched semi-finished product obtained in step S6 and cooled to obtain a hollow fiber membrane, wherein the temperature of the heat-shaping was 170° C. and the heat-shaping was performed for 1 min.

Example 6 provided a method for preparing a degassing hollow fiber membrane, specifically including the following steps:
S1, spinning, namely PP was melted and extruded to form a semi-formed product with a hollow inner cavity under the action of nitrogen, wherein the flow velocity of the nitrogen was 0.035 ml/min, the melt index of the PP was 4 g/min@(190° C., 5 kg), the extrusion thickness of a die head was 2.1 mm, the extrusion temperature of the die head was 200° C., the length-diameter ratio of the die head was 3.5, the molecular weight of the PP was 80,000, the molecular weight distribution index of the PP was 3.5, the isotacticity of the PP was greater than 99% and the crystallinity was 70%;
S2, pre-crystallizing, namely, the semi-formed product obtained in step S1 was cooled and pre-crystallized in an air-cooling manner to obtain a pre-crystallized semi-finished product, wherein the temperature of the air-cooling was 80° C. and the air-cooling distance of the semi-finished product was 900 mm;
S3, wind-cooling for crystallization, namely secondary cooling for crystallization was performed on the pre-crystallized semi-finished product obtained in step S2 in a wind-cooling manner and the semi-finished product was rolled to obtain a cooled semi-finished product, wherein the wind-cooling length of the pre-crystallized semi-finished product was 7 m, the temperature of the wind-cooling was 70° C. and the airflow velocity in the process of the wind-cooling for crystallization was 60 m/min;
S4, annealing for shaping, namely the cooled semi-finished product obtained in step S3 was heat-shaped and cooled to obtain a heat-shaped semi-finished product, wherein the annealing for shaping reduced the temperature to 80° C. and was performed for 45 min;
S5, twice cold-stretching for pore-forming, namely a first cold-stretching treatment was performed on the heat-shaped semi-finished product obtained in step S4 at the rate of 10%/min and the stretching ratio of 21% to obtain a first cold-stretched semi-finished product; and a secondary cold-stretching treatment was performed on the semi-finished product at the rate of 23%/min and the stretching ratio of 16% to obtain a secondary cold-stretched semi-finished product, wherein the temperature of the first cold-stretching was 40° C. and the temperature of the secondary cold-stretching was 35° C.;
S6, heat-stretching for pore-expanding, namely the cold-stretched semi-finished product obtained in step S5 was heat-stretched for pore-expanding to obtain a heat-stretched semi-finished product, wherein the temperature of the heat-stretching was 105° C., the rate of the heat-stretching was 23% of that of the first cold-stretching and the stretching ratio of the heat-stretching was 6 times of that of the first cold-stretching; and
S7, heat-shaping, namely a secondary heat-shaping treatment was performed on the heat-stretched semi-finished product obtained in step S6 and cooled to obtain a hollow fiber membrane, wherein the temperature of the heat-shaping was 95° C. and the heat-shaping was performed for 3 min.

Comparative example 1 provided a method for preparing a degassing hollow fiber membrane, specifically including the following steps:
S1, spinning, namely PP was melted and extruded to form a semi-formed product with a hollow inner cavity under the action of nitrogen, wherein the flow velocity of the nitrogen was 0.2 ml/min, the melt index of the PP was 0.5 g/min@(190° C., 5 kg), the extrusion thickness of a die head was 3 mm, the extrusion temperature of the die head was 210° C., the length-diameter ratio of the die head was 3, the molecular weight of the PP was 85,000, the molecular weight distribution index of the PP was 4.5, the isotacticity of the PP was greater than 99% and the crystallinity was 50%;
S2, pre-crystallizing, namely, the semi-formed product obtained in step S1 was cooled and pre-crystallized in an air-cooling manner to obtain a pre-crystallized semi-finished product, wherein the temperature of the air-cooling was 100° C. lower than the temperature of the die head extruding and the air-cooling distance of the semi-finished product was 500 mm;
S3, wind-cooling for crystallization, namely secondary cooling for crystallization was performed on the pre-crystallized semi-finished product obtained in step S2 in a wind-cooling manner and the semi-finished product was rolled to obtain a cooled semi-finished product, wherein the wind-cooling length of the pre-crystallized semi-finished product was 4.5 m, the temperature of the wind-cooling was 65° C. and the airflow velocity in the process of the wind-cooling for crystallization was 55 m/min;
S4, annealing for shaping, namely the cooled semi-finished product obtained in step S3 was heat-shaped and cooled to obtain a heat-shaped semi-finished product, wherein the annealing for shaping reduced the temperature to 90° C. and was performed for 48 min;
S5, twice cold-stretching for pore-forming, namely a first cold-stretching treatment was performed on the heat-shaped semi-finished product obtained in step S4 at the rate of 15%/min and the stretching ratio of 25% to obtain a first cold-stretched semi-finished product; and a secondary cold-stretching treatment was performed on the semi-finished product at the rate of 20%/min and the stretching ratio of 10% to obtain a secondary cold-stretched semi-finished product, wherein the temperature of the first cold-stretching was 30° C. and the temperature of the secondary cold-stretching was 20° C.;
S6, heat-stretching for pore-expanding, namely the cold-stretched semi-finished product obtained in step S5 was heat-stretched for pore-expanding to obtain a heat-stretched semi-finished product, wherein the temperature of the heat-stretching was 100° C., the rate of the heat-stretching was 15% of that of the first cold-stretching and the stretching ratio of the heat-stretching was 6.5 times of that of the first cold-stretching; and
S7, heat-shaping, namely a secondary heat-shaping treatment was performed on the heat-stretched semi-finished product obtained in step S6 and cooled to obtain a hollow fiber membrane, wherein the temperature of the heat-shaping was 100° C. and the heat-shaping was performed for 2 min.

Under the condition of same parameters as other steps of example 1, comparative example 1 changed the melt index of the PP, the extrusion thickness of the die head and the flow velocity of the nitrogen, thereby increasing the thickness of the hollow fiber membrane and decreasing the uniformity of membrane walls.

Comparative example 2 provided a method for preparing a degassing hollow fiber membrane, specifically including the following steps:
S1, spinning, namely PP was melted and extruded to form a semi-formed product with a hollow inner cavity under the action of nitrogen, wherein the flow velocity of the nitrogen was 0.25 ml/min, the melt index of the PP was 4.5 g/min@(190° C., 5 kg), the extrusion thickness of a die head was 1.8 mm, the extrusion temperature of the die head was 210° C., the length-diameter ratio of the die head was 3, the molecular weight of the PP was 85,000, the molecular weight distribution index of the PP was 4.5, the isotacticity of the PP was greater than 99% and the crystallinity was 50%;
S2, pre-crystallizing, namely, the semi-formed product obtained in step S1 was cooled and pre-crystallized in an air-cooling manner to obtain a pre-crystallized semi-finished product, wherein the temperature of the air-cooling was 100° C. lower than the temperature of the die head extruding and the air-cooling distance of the semi-finished product was 500 mm;
S3, wind-cooling for crystallization, namely secondary cooling for crystallization was performed on the pre-crystallized semi-finished product obtained in step S2 in a wind-cooling manner and the semi-finished product was rolled to obtain a cooled semi-finished product, wherein the wind-cooling length of the pre-crystallized semi-finished product was 4.5 m, the temperature of the wind-cooling was 65° C. and the airflow velocity in the process of the wind-cooling for crystallization was 55 m/min;
S4, annealing for shaping, namely the cooled semi-finished product obtained in step S3 was heat-shaped and cooled to obtain a heat-shaped semi-finished product, wherein the annealing for shaping reduced the temperature to 90° C. and was performed for 48 min;
S5, twice cold-stretching for pore-forming, namely a first cold-stretching treatment was performed on the heat-shaped semi-finished product obtained in step S4 at the rate of 35%/min and the stretching ratio of 10% to obtain a first cold-stretched semi-finished product; and a secondary cold-stretching treatment was performed on the semi-finished product at the rate of 40%/min and the stretching ratio of 3% to obtain a secondary cold-stretched semi-finished product, wherein the temperature of the first cold-stretching was 40° C. and the temperature of the secondary cold-stretching was 30° C.;
S6, heat-stretching for pore-expanding, namely the cold-stretched semi-finished product obtained in step S5 was heat-stretched for pore-expanding to obtain a heat-stretched semi-finished product, wherein the temperature of the heat-stretching was 100° C., the rate of the heat-stretching was 15% of that of the first cold-stretching and the stretching ratio of the heat-stretching was 6.5 times of that of the first cold-stretching; and
S7, heat-shaping, namely a secondary heat-shaping treatment was performed on the heat-stretched semi-finished product obtained in step S6 and cooled to obtain a hollow fiber membrane, wherein the temperature of the heat-shaping was 100° C. and the heat-shaping was performed for 2 min.

Under the condition of same parameters as other steps of example 1, comparative example 2 changed the stretching rate and stretching ratio of the two cold-stretching, thereby reducing the porosity of the hollow fiber membrane and further reducing the gas throughput of the hollow fiber membrane.

### Performance Experiments

### I. Structural Characterization

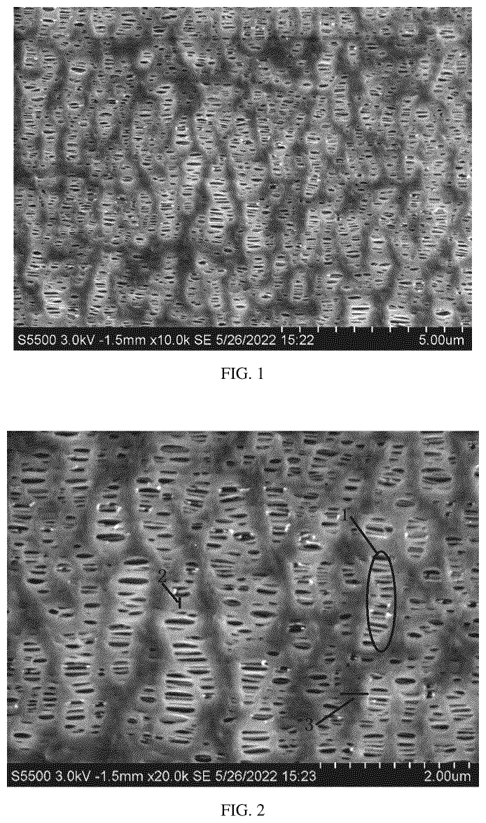

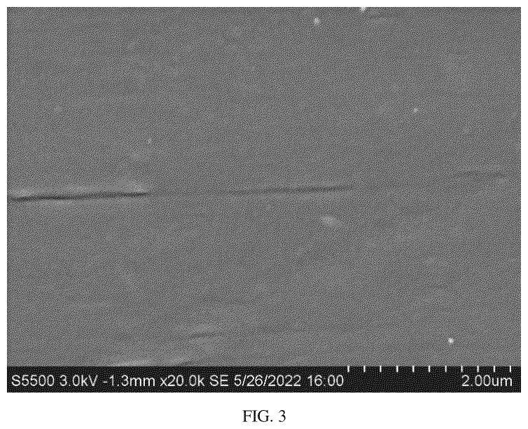

The hollow fiber membranes obtained in each example and comparative example were subjected to the morphological characterization of longitudinal sections, inner surfaces and outer surfaces, the measurement of thickness and average pore diameter of each layer in the main body, the measurement of average fiber diameter, porosity and degree of hollowness of the hollow fiber membranes, and the tests of the area ratio of the air pores and air permeable areas in the inner surface, wherein the measurement data were shown in tables 1-4 and the morphological characterization results of example 4 were shown in FIGS. 1-3.

In table 1, the wall thickness uniformity referred that the membrane wall thickness of the hollow fiber membranes obtained in each example or comparative example was measured, namely, each hollow fiber membrane was cut into 4 sections and the wall thickness of each section was measured with an interval of 20 cm for each measurement. The maximum value of the wall thickness was recorded as dmax, the minimum value of the wall thickness was recorded as dmin, and the average wall thickness Δd was calculated according to the wall thickness measured by four times. The wall thickness uniformity was calculated according to the following formula:

$$Wall thickness uniformity + \frac{d max - d min}{Δ d} \times 100 \%$$

The smaller wall thickness uniformity indicated that the thickness of the hollow fiber membrane was more uniform. The uniformity of the general wall thickness is less than or equal to 5%.

TABLE 1
Characterization of membrane structures in each example (1)

| | | | Average | Average | |
|---|---|---|---|---|---|
| | | Thickness | major | minor | |
| | Membrane | of skin | axis of | axis of | Width of |
| | thickness | layer | air pores | air pores | crack |
| No. | (μm) | (μm) | (nm) | (nm) | (nm) |
| Example 1 | 48 | 2.1 | 256 | 37 | — |
| Example 2 | 57 | 3.7 | 247 | 56 | — |
| Example 3 | 61 | 3.0 | 263 | 47 | — |
| Example 4 | 53 | 2.1 | 252 | 51 | 12 |
| Example 5 | 50 | 2.8 | 261 | 40 | — |
| Example 6 | 46 | 1.5 | 281 | 55 | — |
| Comparative | 78 | 7.5 | 232 | 29 | — |
| example 1 | | | | | |
| Comparative | 47 | 2.1 | 408 | 72 | — |
| example 2 | | | | | |

TABLE 2
Characterization of membrane structures
in each example (2) distance

| | | | Diameter of | Length of air |
|---|---|---|---|---|
| | First | Second | fibers in | permeable |
| | distance | distance | porous area | area |
| No. | (nm) | (nm) | (nm) | (nm) |
| Example 1 | 247 | 132 | 120 | 645 |
| Example 2 | 284 | 239 | 198 | 598 |
| Example 3 | 223 | 116 | 103 | 732 |
| Example 4 | 253 | 124 | 134 | 602 |
| Example 5 | 230 | 119 | 124 | 516 |
| Example 6 | 189 | 97 | 100 | 784 |
| Comparative | 323 | 206 | 203 | 546 |
| example 1 | | | | |
| Comparative | 339 | 253 | 296 | 798 |
| example 2 | | | | |

TABLE 3
Characterization of membrane structures
in each example (3) thickness

| | Area ratio of | Area ratio of air | Wall thickness |
|---|---|---|---|
| | air pores in | pores in air | uniformity of hollow |
| | inner surface | permeable area | fiber membrane |
| No. | (%) | (%) | (%) |
| Example 1 | 22 | 57 | 2.5 |
| Example 2 | 19 | 53 | 2.7 |
| Example 3 | 23 | 61 | 4.2 |
| Example 4 | 21 | 58 | 2.3 |
| Example 5 | 20 | 55 | 2.6 |
| Example 6 | 29 | 65 | 3.2 |
| Comparative | 15 | 28 | 7.5 |
| example 1 | | | |
| Comparative | 12 | 20 | 3.1 |
| example 2 | | | |

TABLE 4
Characterization of membrane structures in each example (4)

| | Degree of | | Average pore | |
|---|---|---|---|---|
| | hollowness of | Porosity | diameter change | Outer |
| | hollow fiber | of porous | gradient of | surface |
| | membrane | area | porous area | energy |
| No. | (%) | (%) | (nm/μm) | (mN/m) |
| Example 1 | 42 | 59 | 2.0 | 26 |
| Example 2 | 39 | 52 | 2.2 | 27 |
| Example 3 | 40 | 63 | 1.9 | 29 |
| Example 4 | 44 | 56 | 2.1 | 28 |
| Example 5 | 40 | 54 | 2.5 | 23 |
| Example 6 | 37 | 69 | 1.8 | 29 |
| Comparative | 15 | 43 | 2.4 | 28 |
| example 1 | | | | |
| Comparative | 41 | 32 | 6.5 | 27 |
| example 2 | | | | |

### II. Performance Tests

The hollow fiber membranes obtained in each example were subjected to a test of tensile performance. The tensile strength was tested by using a tensile tester.

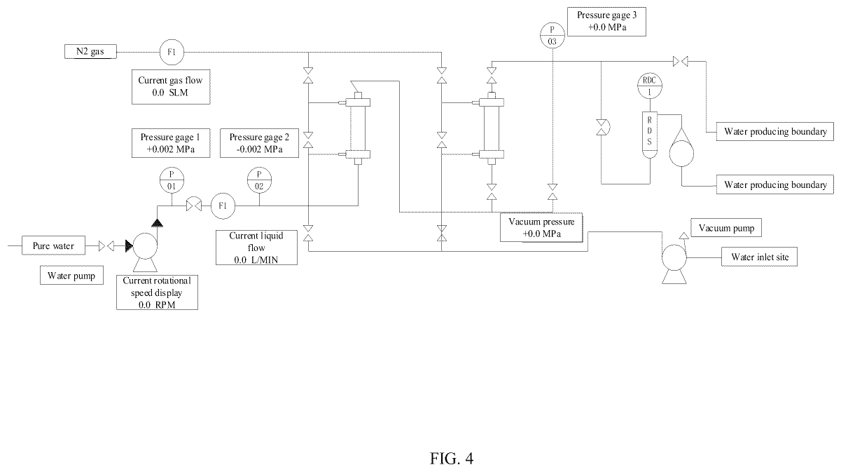

The hollow fiber membranes obtained in each example were subjected to a test of gas throughput. FIG. 4 was a schematic diagram of an apparatus for a deoxidation efficiency test.

The hollow fiber membranes prepared in each example or comparative example were used as a raw material to be assembled into a component with the membrane area of 0.1 mm². The component was used as a test sample for detecting the gas throughput.

Gas with the pressure of 0.1 Mpa was introduced into an inlet of the component, wherein the gas was oxygen and carbon dioxide respectively. An outlet of the component was connected with a flowmeter to record the gas throughput of the component in unit time.

In general, the greater gas throughput indicated that the component had the greater degassing efficiency. Correspondingly, the hollow fiber membrane had the higher degassing efficiency.

The hollow fiber membranes prepared in each example or comparative example were used as a raw material to be assembled into a component with the membrane area of 0.65 mm². Besides, a dissolved oxygen meter, a water path and the component were connected to perform a test. The water path was used for conveying degassing liquid, the component was used for degassing the degassing liquid, and the dissolved oxygen meter was used for detecting the oxygen content of the degassing liquid after the degassing.

The degassing liquid flew outside the membrane, was deionized water and had the temperature of 25° C. The inner side of the membrane was subjected to vacuum blowing.

Step 1, the initial oxygen content of the degassing liquid was detected. The degassing liquid was pumped into the water path, a vacuum device was closed at this time, such that the inner side of the membrane was in a normal pressure state, the degassing liquid passed through the dissolved oxygen meter after passing through the component (without degassing), and the flow of the degassing liquid entering the dissolved oxygen meter was kept to be about 1.8 GLH. The change of the reading of the dissolved oxygen on the dissolved oxygen meter was observed in real time. After the reading of the dissolved oxygen meter was stable (the change of the reading of the dissolved oxygen meter was lower than 1% within 5 min), the reading Oₛₜₐᵣₜ of the dissolved oxygen on the dissolved oxygen meter was read.

Step 2, the final oxygen content of the degassing liquid after the degassing was detected. On the basis of step 1, the vacuum device was opened to perform vacuum blowing on the inner layer of the membrane so as to degas the degassing liquid, wherein the vacuum degree index was kept to be −0.094 MPa (50 torr) during the vacuum blowing. The change of the reading of the dissolved oxygen on the dissolved oxygen meter was observed in real time. After the reading of the dissolved oxygen meter was stable (the change of the reading of the dissolved oxygen meter was lower than 1% within 5 min), it was regarded that the degassing was started and reached a balance, and the reading O_{end} of the dissolved oxygen on the dissolved oxygen meter was read. The deoxidation efficiency was calculated according to the following formula:

$$Deoxidation efficiency = ( 1 - \frac{{O}_{end}}{{O}_{start}} ) \times 100 \% .$$

The hollow fiber membranes obtained in each example were subjected to a test of oxygen permeation rate.

One side of the membrane sample was subjected to a gas to be tested (oxygen and carbon dioxide) at the temperature of 25° C., the pressure of 0.1 bar and the membrane sample area of 0.1 square meter; the gas to be tested was introduced into the inner cavity of the hollow fiber membrane; the volume flow velocity of the gas passing through the membrane wall of the sample was measured with a flow meter (KOFLOC/4800, Japan); and the gas permeation rate of the membrane was determined by taking the average value of 3 measurements from inside the membrane to outside the membrane and 3 measurements from outside the membrane to inside the membrane. Gas permeation rate unit: L/(min·bar·m²)

TABLE 5
Performance test results of each example

| | | | Deoxi- | | Oxygen |
|---|---|---|---|---|---|
| | | | dation | TOC | permeation |
| | Tensile | Elon- | effi- | dissolving- | rate: |
| | strength | gation | ciency | out amount | L/(min · |
| No. | (CN) | (%) | (%) | (μg/L) | bar · m²) |
| Example 1 | 256 | 57 | 87 | 0.21 | 21 |
| Example 2 | 285 | 52 | 83 | 0.32 | 15 |
| Example 3 | 232 | 66 | 90 | 0.39 | 0.003 |
| Example 4 | 206 | 74 | 91 | 0.46 | 30 |
| Example 5 | 247 | 63 | 86 | 0.32 | 0.019 |
| Example 6 | 201 | 81 | 93 | 0.49 | 30 |
| Comparative | 280 | 53 | 43 | 1.70 | 12 |
| example 1 | | | | | |
| Comparative | 275 | 54 | 52 | 1.85 | 14 |
| example 2 | | | | | |

Described above are merely preferred examples of the present application, which are not intended to limit this application. Various changes and modifications can be made to the present application by those skilled in the art. Any modifications, equivalent replacements, improvements, etc. made within the spirit and scope of the present application should be included within the claims of the present application.

What is claimed is:

1. A high-efficiency degassing polyolefin hollow fiber membrane, comprising a main body, wherein one side of the main body is an inner surface facing an inner cavity, the other side of the main body is an outer surface, a non-directional tortuous pathway is formed in the main body, the outer surface is a dense surface, and the area ratio of air pores in the inner surface is 10%-30%;
the average thickness of the hollow fiber membrane is 45-65 m and the ratio of the average outer diameter to the average inner diameter of the hollow fiber membrane is 1.45-1.55;
the TOC dissolving-out amount of the hollow fiber membrane is less than or equal to 3 μg/L; and
the deoxidation efficiency of the hollow fiber membrane is greater than 80%.

2. The high-efficiency degassing polyolefin hollow fiber membrane according to claim 1, wherein the inner surface is provided with a plurality of oval air pores, the major axis of each air pore is oriented to the length direction of the hollow fiber membrane, the minor axis of each air pore is oriented to the circumferential direction of the hollow fiber membrane, the average major axis of the air pores is 150-300 nm, the average minor axis of the air pores is 10-60 nm, and the degree of hollowness of the hollow fiber membrane is 35%-55%.

3. The high-efficiency degassing polyolefin hollow fiber membrane according to claim 1, wherein the difference between the maximum thickness and the minimum thickness of the hollow fiber membrane is less than or equal to 5 μm, and the difference is less than or equal to 10% of the average thickness of the hollow fiber membrane; and
the porosity of the hollow fiber membrane is 30%-50%, and 1.5-3.5 times of the area ratio of the air pores in the inner surface.

4. The high-efficiency degassing polyolefin hollow fiber membrane according to claim 1, wherein the average major axis of the air pores is 2-8 times of the average minor axis; and
the difference between the maximum major axis and the minimum major axis of the air pores is 150-350 nm, and the difference between the maximum minor axis and the minimum minor axis of the air pores is 10-100 nm.

5. The high-efficiency degassing polyolefin hollow fiber membrane according to claim 1, wherein in the circumferential direction of the hollow fiber membrane, a plurality of the air pores are regularly arranged to form an air permeable area for air permeability;
the length direction of the air permeable area is consistent with the circumferential direction of the hollow fiber membrane; the width direction of the air permeable area is consistent with the length direction of the hollow fiber membrane; and
the average length of the air permeable area is 400-1,100 nm and greater than the average width of the air permeable area.

6. The high-efficiency degassing polyolefin hollow fiber membrane according to claim 5, wherein in the length direction of the hollow fiber membrane, the distance between two adjacent air permeable areas is a first distance, and the average length of the first distances is 100-350 nm;
in the circumferential direction of the hollow fiber membrane, the distance between two adjacent air permeable areas is a second distance, and the average length of the second distances is 100-300 nm; and the average length of the first distances is less than or equal to 3 times that of the second distances.

7. The high-efficiency degassing polyolefin hollow fiber membrane according to claim 5, wherein the area ratio of the air pores of the air permeable areas is 30%-70% and the area ratio of the air pores of the air permeable areas is 20%-50% greater than that of the air pores in the inner surface; and
the average distance between the adjacent air pores in the length direction of the air permeable areas is 20-70 nm.

8. The high-efficiency degassing polyolefin hollow fiber membrane according to claim 1, wherein the outer surface is also provided with a plurality of crazing cracks and the width of each crack is less than or equal to 20 nm; and the surface energy of the outer surface is 15-40 mN/m.

9. The high-efficiency degassing polyolefin hollow fiber membrane according to claim 1, wherein the main body of the hollow fiber membrane is provided with a skin layer area and a porous area along the thickness direction of the membrane, and continuous fibers are in transition between the skin layer area and the porous area;
one side of the skin layer area is an outer surface and one side of the porous area is an inner surface; and
the thickness of the skin layer area is 0.5-4 μm, the thickness of the skin layer area accounts for 1%-8% of the thickness of the hollow fiber membrane, and the porosity of the skin layer area is less than or equal to 10%.

10. The high-efficiency degassing polyolefin hollow fiber membrane according to claim 9, wherein the average pore diameter of the porous area gradiently changes from the area close to one side of the inner surface to the area close to one side of the outer surface; and
the change gradient of the average pore diameter of the porous area is 1.5-3 nm/μm, the porosity of the porous area is 40%-70%, and the diameter of the fibers of the porous area is 60-300 nm.

11. A method for preparing the high-efficiency degassing polyolefin hollow fiber membrane according to claim 1, comprising the following steps:
S1, spinning, namely melting and extruding polyolefin, and forming a semi-formed product with a hollow inner cavity under the action of a cavity-forming fluid,
wherein the melt index of the polyolefin is 1-7 g/min@(Tm+20° C., 5 kg), the extrusion thickness of a die head is 1.8-2.2 mm and the flow velocity of the cavity-forming fluid of 0.01-0.05 ml/min; and
the polyolefin is any one of PE, PP and PMP;
S2, pre-crystallizing, namely, cooling and pre-crystallizing the semi-formed product obtained in step S1 in an air-cooling manner to obtain a pre-crystallized semi-finished product;
S3, wind-cooling for crystallization, namely performing secondary cooling for crystallization on the pre-crystallized semi-finished product obtained in step S2 in a wind-cooling manner and rolling same to obtain a cooled semi-finished product;
S4, annealing for shaping, namely heat-shaping the cooled semi-finished product obtained in step S3 and cooling same to obtain a heat-shaped semi-finished product;
S5, twice cold-stretching for pore-forming, namely performing a first cold-stretching treatment on the heat-shaped semi-finished product obtained in step S4 at the rate of 10%-25%/min and the stretching ratio of 15%-25% to obtain a first cold-stretched semi-finished product; and performing a secondary cold-stretching treatment on the semi-finished product at the rate of 15%-30%/min and the stretching ratio of 5%-20% to obtain a secondary cold-stretched semi-finished product;
S6, heat-stretching for pore-expanding, namely heat-stretching the cold-stretched semi-finished product obtained in step S5 for pore-expanding to obtain a heat-stretched semi-finished product; and
S7, heat-shaping, namely performing a secondary heat-shaping treatment on the heat-stretched semi-finished product obtained in step S6 and cooling same to obtain a hollow fiber membrane.

12. The method for preparing the high-efficiency degassing polyolefin hollow fiber membrane according to claim 11, wherein in step S1, the extrusion temperature of the die head is (Tm+10)−(Tm+70)° C., the melting point of the polyolefin is Tm, the length-diameter ratio of the die head is 2-5, the molecular weight of the polyolefin is 60,000-100,000, and the molecular weight distribution index of the polyolefin is 1-5.

13. The method for preparing the high-efficiency degassing polyolefin hollow fiber membrane according to claim 11, wherein in step S1, when the polyolefin is PP, the isotacticity of the PP is greater than 99%, the crystallinity is 45%-75% and the melt index is 2-5 g/min@(190° C., 5 kg); or when the polyolefin is PE, the PE is mLLDPE, the density of the mLLDPE is 0.91-0.93 g/cm³, the molecular weight distribution index is 2-2.5 and the degree of branching is 0.1-0.4; or when the polyolefin is PMP, the Vicat softening point of the PMP is 160-170° C.

14. The method for preparing the high-efficiency degassing polyolefin hollow fiber membrane according to claim 11, wherein in step S2, the temperature of the air-cooling is lower than the temperature of the die head extruding by 110-220° C. and the air-cooling distance of the semi-finished product is 30-1,000 mm.

15. The method for preparing the high-efficiency degassing polyolefin hollow fiber membrane according to claim 11, wherein in step S3, the wind-cooling length of the pre-crystallized semi-finished product is 4-8 m, the temperature of the wind-cooling is 40-70° C. and the airflow velocity in the process of the wind-cooling for crystallization is 30-60 m/min.

16. The method for preparing the high-efficiency degassing polyolefin hollow fiber membrane according to claim 11, wherein in step S5, the temperature of the first cold-stretching is 25-72° C. higher than the glass transition temperature of the polyolefin and the temperature of the second cold-stretching is 35-80° C. higher than the glass transition temperature of the polyolefin.

17. The method for preparing the high-efficiency degassing polyolefin hollow fiber membrane according to claim 11, wherein the temperature of the heat-stretching in step S6 is at least 60-103° C. higher than the temperature of the first cold-stretching in step S5; the rate of the heat-stretching is 10%-30% of that of the first cold-stretching; and the stretching ratio of the heat-stretching is 2-7 times of that of the first cold-stretching.

18. The method for preparing the high-efficiency degassing polyolefin hollow fiber membrane according to claim 11, wherein in step S4, the annealing for shaping reduces the temperature to 75-150° C. and is performed for 20-50 min; and
in step S7, the temperature of the heat-shaping is 5-30° C. higher than the annealing temperature; and the heat-shaping is performed for 0.5-3 min.

19. Use of the high-efficiency degassing polyolefin hollow fiber membrane according to claim 1, wherein the polyolefin is PP, the hollow fiber membrane is used for removing oxygen in ultrapure water, the oxygen permeation rate of the hollow fiber membrane is 15-30 L/(min·bar·m²), the tensile strength of the hollow fiber membrane is greater than or equal to 150 CN, and the elongation at break of the hollow fiber membrane is 30%-150%.
